(19) United States
(12) Patent Application Publication
(10) Pub. No.: US 2015/0046679 A1
(43) Pub. Date: Feb. 12, 2015

(54) Energy-Efficient Run-Time Offloading of Dynamically Generated Code in Heterogenuous Multiprocessor Systems

(71) Applicant: QUALCOMM Incorporated, San Diego, CA (US)

(72) Inventors: Sudha Anil Kumar Gathala, Santa Clara, CA (US); Dinakar Dhurjati, San Diego, CA (US); Andrey Ermolinskiy, San Diego, CA (US); Christopher A. Vick, San Jose, CA (US)

(73) Assignee: QUALCOMM Incorporated, San Diego, CA (US)

(21) Appl. No.: 13/961,122

(22) Filed: Aug. 7, 2013

(51) Int. Cl. G06F 9/38

(52) U.S. Cl. CPC G06F 9/3885
USPC 712/30

(57) ABSTRACT

Mobile computing devices may be configured to intelligently select, compile, and execute portions of a general purpose software application in an auxiliary processor (e.g., a DSP) of a multiprocessor system. A processor of the mobile device may be configured to determine whether portions of a software application are suitable for execution in an auxiliary processor, monitor operating conditions of the system, determine a historical context based on the monitoring, and determine whether the portions that were determined to suitable for execution in an auxiliary processor should be compiled for execution in the auxiliary processor based on the historical context. The processor may also be configured to continue monitoring the system, update the historical context information, and determine whether code previously compiled for execution on the auxiliary processor should be invoked or executed in the auxiliary processor based on the updated historical context information.

### BACKGROUND

Mobile and wireless technologies have seen explosive growth over the past several years. This growth has been fueled by better communications, hardware, and more reliable protocols. Wireless service providers are now able to offer their customers an ever-expanding array of features and services, and provide users with unprecedented levels of access to information, resources, and communications. To keep pace with these enhancements, mobile electronic devices (e.g., cellular phones, watches, headphones, remote controls, etc.) have become more complex than ever, and now commonly include multiple processors, system-on-chips (SoCs), and other resources that allow mobile device users to execute complex and power intensive software applications (e.g., video streaming, video processing, etc.) on their mobile devices. With this rise in complexity and power consumption, new and improved processing solutions that better utilize the mobile device's resources and capabilities will be beneficial to consumers.

### SUMMARY

The various aspects include methods of offloading portions of a general purpose software application to an auxiliary processor of a multiprocessor computing device, which may include monitoring in an application processor a plurality of operating conditions of the multiprocessor computing device, generating historical context information based on the monitoring, determining whether a segment of the general purpose software application can be compiled for execution in the auxiliary processor, determining whether the segment should be offloaded to the auxiliary processor based on the historical context information and in response to determining that the segment can compiled for execution in the auxiliary processor, and compiling the segment of the general purpose software application into code suitable for execution in the auxiliary processor in response to determining that the segment should be offloaded.

In an aspect, the method may include continuing to monitor the plurality of operating conditions of the multiprocessor computing device, updating the historical context information based on the continued monitoring, determining whether the compiled segment should be executed in the auxiliary processor based on the updated historical context information, executing the compiled segment in the auxiliary processor when the updated historical context information indicates that the compiled segment should be executed in the auxiliary processor, and compiling and executing the segment of the general purpose software application in the application processor when the updated historical context information indicates that the compiled segment should not be executed in the auxiliary processor.

In a further aspect, determining whether the segment should be offloaded to the auxiliary processor based on the historical context information may be based on an execution history of the auxiliary processor. In a further aspect, determining whether the segment should be offloaded to the auxiliary processor based on an execution history of the auxiliary processor may include determining whether the segment should be offloaded to the auxiliary processor based on historical information regarding tasks scheduled for execution in the auxiliary processor. In a further aspect, determining whether the segment should be offloaded to the auxiliary processor based on the historical context information may include determining whether the segment should be offloaded to the auxiliary processor based on historical power state and operating frequency information of the auxiliary processor.

In a further aspect, determining whether the compiled segment should be executed in the auxiliary processor based on the updated historical context information may include determining whether improvements in performance or power consumption will be achieved by executing the segment in the auxiliary processor based on an execution history of the auxiliary processor. In a further aspect, executing the compiled segment in the auxiliary processor when the updated historical context information indicates that the compiled segment should be executed in the auxiliary processor may include executing the compiled segment only when the updated historical context information indicates that improvements in performance or power consumption will be achieved by executing the compiled segment in the auxiliary processor. In a further aspect, monitoring the plurality of operating conditions of the multiprocessor computing device may include monitoring a number of tasks scheduled for execution in the auxiliary processor, a current power state of the auxiliary processor, and an operating frequency of the auxiliary processor.

In a further aspect, determining whether the segment should be offloaded to the auxiliary processor based on the historical context information may include determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor. In a further aspect, compiling the segment of the general purpose software application into code suitable for execution in the auxiliary processor in response to determining that the segment should be offloaded may include compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

In a further aspect, determining whether the segment of the general purpose software application can be compiled for execution in the auxiliary processor may include analyzing the general purpose software application to identify operations that are required to be performed during its execution, partitioning the general purpose software application into code units based on identified operations, and determining whether the auxiliary processor is capable of performing the identified operations.

In a further aspect, determining whether the segment of the general purpose software application can be compiled for execution in the auxiliary processor may include determining whether the segment can be compiled for execution in a digital signal processor.

In a further aspect, monitoring the plurality of operating conditions of the multiprocessor computing device may include monitoring two or more of a power state of the auxiliary processor, an amount of time the auxiliary processor has remained in its current power state, a predicted amount of time that the auxiliary processor will remain in its current power state, an amount of time required to cause the auxiliary processor to exit its current power state, an operating frequency of the auxiliary processor, a run queue of the auxiliary processor, a power state of the application processor, an operating frequency of the application processor, a run queue of the application processor, and a power state of a resource in the multiprocessor computing device.

Further aspects include a multiprocessor computing device having means for monitoring in an application processor a plurality of operating conditions, means for generating historical context information based on the monitoring, means for determining whether a segment of a general purpose software application can be compiled for execution in an auxiliary processor of the multiprocessor computing device, means for determining whether the segment should be offloaded to the auxiliary processor based on the historical context information and in response to determining that the segment can compiled for execution in the auxiliary processor, and means for compiling the segment of the general purpose software application into code suitable for execution in the auxiliary processor in response to determining that the segment should be offloaded.

In an aspect, the multiprocessor computing device may include means for continuing to monitor the plurality of operating conditions, means for updating the historical context information based on the continued monitoring, means for determining whether the compiled segment should be executed in the auxiliary processor based on the updated historical context information, means for executing the compiled segment in the auxiliary processor when the updated historical context information indicates that the compiled segment should be executed in the auxiliary processor, and means for compiling and executing the segment of the general purpose software application in the application processor when the updated historical context information indicates that the compiled segment should not be executed in the auxiliary processor.

In a further aspect, means for determining whether the segment should be offloaded to the auxiliary processor based on the historical context information may include means for determining whether the segment should be offloaded to the auxiliary processor based on an execution history of the auxiliary processor. In a further aspect, means for determining whether the segment should be offloaded to the auxiliary processor based on an execution history of the auxiliary processor may include means for determining whether the segment should be offloaded to the auxiliary processor based on historical information regarding tasks scheduled for execution in the auxiliary processor. In a further aspect, means for determining whether the segment should be offloaded to the auxiliary processor based on the historical context information may include means for determining whether the segment should be offloaded to the auxiliary processor based on historical power state and operating frequency information of the auxiliary processor.

In a further aspect, means for determining whether the compiled segment should be executed in the auxiliary processor based on the updated historical context information may include means for determining whether improvements in performance or power consumption will be achieved by executing the segment in the auxiliary processor based on an execution history of the auxiliary processor. In a further aspect, means for executing the compiled segment in the auxiliary processor when the updated historical context information indicates that the compiled segment should be executed in the auxiliary processor may include means for executing the compiled segment only when the updated historical context information indicates that improvements in performance or power consumption will be achieved by executing the compiled segment in the auxiliary processor.

In a further aspect, means for monitoring the plurality of operating conditions may include means for monitoring a number of tasks scheduled for execution in the auxiliary processor, a current power state of the auxiliary processor, and an operating frequency of the auxiliary processor. In a further aspect, means for determining whether the segment should be offloaded to the auxiliary processor based on the historical context information may include means for determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor. In a further aspect, means for compiling the segment of the general purpose software application into code suitable for execution in the auxiliary processor in response to determining that the segment should be offloaded may include means for compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

In a further aspect, means for determining whether the segment of the general purpose software application can be compiled for execution in the auxiliary processor may include means for analyzing the general purpose software application to identify operations that are required to be performed during its execution, means for partitioning the general purpose software application into code units based on identified operations, and means for determining whether the auxiliary processor is capable of performing the identified operations.

In a further aspect, means for determining whether the segment of the general purpose software application can be compiled for execution in the auxiliary processor may include means for determining whether the segment can be compiled for execution in a digital signal processor.

In a further aspect, means for monitoring the plurality of operating conditions may include means for monitoring two or more of a power state of the auxiliary processor, an amount of time the auxiliary processor has remained in its current power state, a predicted amount of time that the auxiliary processor will remain in its current power state, an amount of time required to cause the auxiliary processor to exit its current power state, an operating frequency of the auxiliary processor, a run queue of the auxiliary processor, a power state of the application processor, an operating frequency of the application processor, a run queue of the application processor, and a power state of a resource in the multiprocessor computing device.

Further aspects include a multiprocessor computing device that may include an application processor and an auxiliary processor, in which the application processor may be configured with processor-executable instructions to perform operations including monitoring a plurality of operating conditions, generating historical context information based on the monitoring, determining whether a segment of a general purpose software application can be compiled for execution in the auxiliary processor, determining whether the segment should be offloaded to the auxiliary processor based on the historical context information and in response to determining that the segment can compiled for execution in the auxiliary processor, and compiling the segment of the general purpose software application into code suitable for execution in the auxiliary processor in response to determining that the segment should be offloaded.

In an aspect, the application processor may be configured with processor-executable instructions to perform operations further including continuing to monitor the plurality of operating conditions, updating the historical context information based on the continued monitoring, determining whether the compiled segment should be executed in the auxiliary processor based on the updated historical context information, causing the auxiliary processor to execute the compiled segment when the updated historical context information indicates that the compiled segment should be executed in the auxiliary processor, and compiling and executing the segment of the general purpose software application in the application processor when the updated historical context information indicates that the compiled segment should not be executed in the auxiliary processor.

In a further aspect, the application processor may be configured with processor-executable instructions to perform operations such that determining whether the segment should be offloaded to the auxiliary processor based on the historical context information may include determining whether the segment should be offloaded to the auxiliary processor based on an execution history of the auxiliary processor. In a further aspect, the application processor may be configured with processor-executable instructions to perform operations such that determining whether the segment should be offloaded to the auxiliary processor based on an execution history of the auxiliary processor may include determining whether the segment should be offloaded to the auxiliary processor based on historical information regarding tasks scheduled for execution in the auxiliary processor. In a further aspect, the application processor may be configured with processor-executable instructions to perform operations such that determining whether the segment should be offloaded to the auxiliary processor based on the historical context information may include determining whether the segment should be offloaded to the auxiliary processor based on historical power state and operating frequency information of the auxiliary processor.

In a further aspect, the application processor may be configured with processor-executable instructions to perform operations such that determining whether the compiled segment should be executed in the auxiliary processor based on the updated historical context information may include determining whether improvements in performance or power consumption will be achieved by executing the segment in the auxiliary processor based on an execution history of the auxiliary processor, and executing the compiled segment in the auxiliary processor when the updated historical context information indicates that the compiled segment should be executed in the auxiliary processor may include executing the compiled segment only when the updated historical context information indicates that improvements in performance or power consumption will be achieved by executing the compiled segment in the auxiliary processor.

In a further aspect, the application processor may be configured with processor-executable instructions to perform operations such that monitoring the plurality of operating conditions may include monitoring a number of tasks scheduled for execution in the auxiliary processor, a current power state of the auxiliary processor, and an operating frequency of the auxiliary processor, determining whether the segment should be offloaded to the auxiliary processor based on the historical context information may include determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor, and compiling the segment of the general purpose software application into code suitable for execution in the auxiliary processor in response to determining that the segment should be offloaded may include compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

In a further aspect, the application processor may be configured with processor-executable instructions to perform operations such that determining whether the segment of the general purpose software application can be compiled for execution in the auxiliary processor may include analyzing the general purpose software application to identify operations that are required to be performed during its execution, partitioning the general purpose software application into code units based on identified operations, and determining whether the auxiliary processor is capable of performing the identified operations.

In a further aspect, the application processor may be configured with processor-executable instructions to perform operations such that determining whether the segment of the general purpose software application can be compiled for execution in the auxiliary processor may include determining whether the segment can be compiled for execution in a digital signal processor.

In a further aspect, the application processor may be configured with processor-executable instructions to perform operations such that monitoring the plurality of operating conditions of the multiprocessor computing device may include monitoring two or more of a power state of the auxiliary processor, an amount of time the auxiliary processor has remained in its current power state, a predicted amount of time that the auxiliary processor will remain in its current power state, an amount of time required to cause the auxiliary processor to exit its current power state, an operating frequency of the auxiliary processor, a run queue of the auxiliary processor, a power state of the application processor, an operating frequency of the application processor, a run queue of the application processor, and a power state of a resource in the multiprocessor computing device.

Further aspects include a non-transitory computer readable storage medium having stored thereon processor-executable software instructions configured to cause an application processor of a multiprocessor computing device to perform operations for offloading portions of a general purpose software application to an auxiliary processor in which the operations include monitoring a plurality of operating conditions, generating historical context information based on the monitoring, determining whether a segment of the general purpose software application can be compiled for execution in the auxiliary processor, determining whether the segment should be offloaded to the auxiliary processor based on the historical context information and in response to determining that the segment can compiled for execution in the auxiliary processor, and compiling the segment of the general purpose software application into code suitable for execution in the auxiliary processor in response to determining that the segment should be offloaded.

In an aspect, the stored processor-executable software instructions may be configured to cause the application processor to perform operations further including continuing to monitor the plurality of operating conditions, updating the historical context information based on the continued monitoring, determining whether the compiled segment should be executed in the auxiliary processor based on the updated historical context information, causing the auxiliary processor to execute the compiled segment when the updated historical context information indicates that the compiled segment should be executed in the auxiliary processor, and compiling and executing the segment of the general purpose software application in the application processor when the updated historical context information indicates that the compiled segment should not be executed in the auxiliary processor.

In a further aspect, the stored processor-executable software instructions may be configured to cause the application processor to perform operations such that determining whether the segment should be offloaded to the auxiliary processor based on the historical context information may include determining whether the segment should be offloaded to the auxiliary processor based on an execution history of the auxiliary processor. In a further aspect, the stored processor-executable software instructions may be configured to cause the application processor to perform operations such that determining whether the segment should be offloaded to the auxiliary processor based on an execution history of the auxiliary processor may include determining whether the segment should be offloaded to the auxiliary processor based on historical information regarding tasks scheduled for execution in the auxiliary processor. In a further aspect, the stored processor-executable software instructions may be configured to cause the application processor to perform operations such that determining whether the segment should be offloaded to the auxiliary processor based on the historical context information may include determining whether the segment should be offloaded to the auxiliary processor based on historical power state and operating frequency information of the auxiliary processor.

In a further aspect, the stored processor-executable software instructions may be configured to cause the application processor to perform operations such that determining whether the compiled segment should be executed in the auxiliary processor based on the updated historical context information may include determining whether improvements in performance or power consumption will be achieved by executing the segment in the auxiliary processor based on an execution history of the auxiliary processor.

In a further aspect, the stored processor-executable software instructions may be configured to cause the application processor to perform operations such that executing the compiled segment in the auxiliary processor when the updated historical context information indicates that the compiled segment should be executed in the auxiliary processor may include executing the compiled segment only when the updated historical context information indicates that improvements in performance or power consumption will be achieved by executing the compiled segment in the auxiliary processor.

In a further aspect, the stored processor-executable software instructions may be configured to cause the application processor to perform operations such that monitoring the plurality of operating conditions of the multiprocessor computing device may include monitoring a number of tasks scheduled for execution in the auxiliary processor, a current power state of the auxiliary processor, and an operating frequency of the auxiliary processor.

In a further aspect, the stored processor-executable software instructions may be configured to cause the application processor to perform operations such that determining whether the segment should be offloaded to the auxiliary processor based on the historical context information may include determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor.

In a further aspect, the stored processor-executable software instructions may be configured to cause the application processor to perform operations such that compiling the segment of the general purpose software application into code suitable for execution in the auxiliary processor in response to determining that the segment should be offloaded may include compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

In a further aspect, the stored processor-executable software instructions may be configured to cause the application processor to perform operations such that determining whether the segment of the general purpose software application can be compiled for execution in the auxiliary processor may include analyzing the general purpose software application to identify operations that are required to be performed during its execution, partitioning the general purpose software application into code units based on identified operations, and determining whether the auxiliary processor is capable of performing the identified operations.

In a further aspect, the stored processor-executable software instructions may be configured to cause the application processor to perform operations such that determining whether the segment of the general purpose software application can be compiled for execution in the auxiliary processor may include determining whether the segment can be compiled for execution in a digital signal processor.

In a further aspect, the stored processor-executable software instructions may be configured to cause the application processor to perform operations such that monitoring the plurality of operating conditions of the multiprocessor computing device may include monitoring two or more of a power state of the auxiliary processor, an amount of time the auxiliary processor has remained in its current power state, a predicted amount of time that the auxiliary processor will remain in its current power state, an amount of time required to cause the auxiliary processor to exit its current power state, an operating frequency of the auxiliary processor, a run queue of the auxiliary processor, a power state of the application processor, an operating frequency of the application processor, a run queue of the application processor, and a power state of a resource in the multiprocessor computing device.

### BRIEF DESCRIPTION OF THE DRAWINGS

The accompanying drawings, which are incorporated herein and constitute part of this specification, illustrate exemplary aspect of the invention, and together with the general description given above and the detailed description given below, serve to explain the features of the invention.

FIG. 1 is an architectural diagram of an example system on chip suitable for implementing the various aspects.

FIG. 2 is a functional block diagram illustrating example logical and functional components in an aspect multiprocessor computing system configured to compile portions of a general purpose software application for execution in an auxiliary processor.

FIG. 3 is a functional block diagram illustrating example logical and functional components in an aspect multiprocessor computing system that may be configured to monitor operating conditions of the device to generate historical context information and compile portions of a general purpose application for execution on an auxiliary processor based on the historical context information.

FIG. 4 is a process flow diagram of an aspect method of compiling portions of a general purpose software application for execution in an auxiliary processor of a multiprocessor device.

FIG. 5 is a process flow diagram of an aspect method of executing previously compiled portions of a general purpose software application in a multiprocessor computing device.

FIG. 6 is a block diagram of an example smartphone suitable for use with the various aspects.

FIG. 7 is a block diagram of an example laptop computer suitable for use with the various aspects.

FIG. 8 is a block diagram of an example server computer suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various aspects include methods, as well as processors configured to perform the methods, of intelligently selecting, compiling, and executing portions of a general purpose software application on an auxiliary processor (e.g., a DSP) of a multiprocessor system. In an aspect, a processor in a multiprocessor system may be configured to monitor a plurality of factors and operating conditions in the system and determine a historical context based on the monitoring. The processor may also be configured to determine the portions of the general purpose software application that may be compiled for execution in an auxiliary processor, and determine whether the portions determined to be suitable for execution in the auxiliary processor should actually be compiled for execution in the auxiliary processor based on the historical context. The processor may be further configured to compile portions of the software application into code suitable for execution in the auxiliary processor, continue monitoring the system to update the historical context information, and determine whether code previously compiled for execution on the auxiliary processor should be invoked or executed in the auxiliary processor based on the updated historical context information.

By intelligently selecting code portions for compilation and/or execution in the auxiliary processor, the various aspects enable significant gains in performance, efficiency, and/or power consumption to be realized in the computing device when compared to existing offloading solutions or to conventional solutions of executing the entire general purpose application in the main applications processor or central processing unit (CPU) of the computing device.

The terms “computing system” and “computing device” are used generically herein to refer to any one or all of servers, personal computers, and mobile devices, such as cellular telephones, smartphones, tablet computers, laptop computers, netbooks, ultrabooks, palm-top computers, personal data assistants (PDA's), wireless electronic mail receivers, multimedia Internet enabled cellular telephones, Global Positioning System (GPS) receivers, wireless gaming controllers, and similar personal electronic devices which include a programmable processor. While the various aspects are particularly useful in mobile devices, such as smartphones, which have limited processing power and battery life, the aspects are generally useful in any computing device that includes a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “multicore processor” is used herein to refer to a single integrated circuit (IC) chip or chip package that contains two or more independent processing cores (e.g., CPU cores, IP cores, etc.) configured to read and execute program instructions. A SOC may include multiple multicore processors, and each processor in an SOC may be referred to as a core. The term “multiprocessor” is used herein to refer to a system or device that includes two or more processing units configured to read and execute program instructions.

Modern mobile computing devices (e.g., smartphones, etc.) commonly include multiple processors, system-on-chips (SoCs), and other resources that allow mobile device users to execute complex and power-intensive software applications (e.g., video streaming, video processing, video games, etc.) on their mobile devices without a wired connection to a power source. As a result, a mobile device's battery life and power consumption characteristics are becoming ever more important considerations for consumers of mobile devices.

To maximize battery life, mobile devices typically implement dynamic voltage and frequency scaling techniques. These techniques allow processors and programmable resources to run in a lower power, lower frequency and/or lower performance mode when non-critical applications or low load conditions are detected. For example, a mobile device may be configured to place one or more of its resources or processors in a low power state when they are idle.

While dynamic voltage and frequency scaling solutions may improve the overall battery performance of a mobile device, they do not improve the power consumption characteristics of individual software applications or processes executing on the device.

Optimizing the individual software applications to reduce the amount of power consumed by the mobile device during their execution will greatly improve the mobile device's battery life and power consumption characteristics. In addition, configuring a mobile device with new and improved compiling and processing solutions that better utilize more of the resources and capabilities available in modern mobile devices will further improve the performance and power consumption characteristics of that mobile device.

Such compiling and processing solutions may include configuring a mobile device to convert or translate portions of the software application code into code that is suitable for execution on an auxiliary processor of the device, and executing different portions of the software application in different processors at the same time. This may be accomplished by configuring the mobile device to analyze the software application's object code, identify the operations that are required to be performed during execution of the object code, partition the object code into object code segments based on identified operations, determine whether an object code segment can be processed in an auxiliary processor, translate one or more object code segments into a format that is suitable for execution in the auxiliary processor, and cause the auxiliary processor to execute the translated object code segments in parallel with the non-translated object code segments.

By executing some code portions in an auxiliary processor, significant gains in performance, efficiency, and/or power consumption may be realized when compared to simply executing the entire application on the main applications processor or CPU of the computing device. However, existing offloading solutions simply determine whether one or more tasks can be offloaded to the auxiliary processor, and translate and execute all such tasks in the auxiliary processor. That is, existing solutions do not make intelligent offloading decisions based on the current or historical operating conditions detected in the mobile device.

Most offloading solutions are static solutions that determine which of the software application's operations will be offloaded to the auxiliary processor in advance of the program's distribution, translation, compilation, or execution in the mobile device. However, it is difficult to predict the operations that should be offloaded in advance of the program's execution. As a result, the use of static offloading solutions in a mobile device typically does not result in significant improvements in the performance or power consumption characteristics of the device.

Generally, the amount of power consumed when executing a software application or accomplishing a given processing task in a mobile computing device varies from one type of device to another. Further, the performance characteristics of a single type of processor (e.g., Intel® Core i7, etc.) can vary significantly from lot-to-lot and chip-to-chip. Due to these variances, it is difficult to optimize software applications in advance of their distribution to, and execution in, a specific mobile computing device.

In addition, modern mobile computing devices are complex systems that include a large number of resources that the device may turn off, disable, idle, or otherwise reduce the energy consumption needs of when one of its processors enters an idle state. When the processor “wakes up” (e.g., leaves the idle state to perform another task), the resources must be turned back on, re-enabled and/or returned to an acceptable operating state before that processor returns to the active state or requires access to those resources. Failure to do so may result in the mobile computing device appearing non-responsive or slow.

Further, placing processors and resources in a low power mode and restoring them to their normal operating modes consumes power. If the amount of time that the processor/resource remains in an idle state is too short, the power consumed in placing that processor/resource into a low power state and returning it to full operation may be more than the power saved during the short time it was in the low power state. Therefore, waking up an auxiliary processor of the mobile device to perform a small, quick, or simple task shortly after the processor has entered a low power state may have a negative impact on the performance and power consumption characteristics of the mobile device.

In addition, each resource's power consumption levels and latency characteristics (i.e., the time required to return the resource to a full power mode) may change with the operating frequencies, temperature, operating states, and other conditions of the mobile device. For example, each resource may consume a different amount of power in its various low power modes and may require a different amount of time or power to enter or leave each mode based on the operating frequencies of the processors and other conditions of the mobile device.

For all these reasons, the benefits of offloading operations to an auxiliary processor may depend upon a variety of factors and conditions of the device, including the operating states and frequencies of the processors, low power states of the resources used by the processors, the amount of time that the auxiliary processor has remained a low power state, the amount of time the auxiliary processor is expected to remain in an idle or low power state, the number of tasks scheduled for execution in the auxiliary processor, the latency associated with waking up the auxiliary processor, the latency associated with waking up the resources used by auxiliary processor, and other similar context information.

Existing static solutions for offloading tasks from a general purpose applications processor to an auxiliary processor do not always improve the performance and power consumption characteristics of the computing device because these solutions make offloading decisions in advance of the program's execution. For example, existing solutions do not monitor a plurality of current or past power states, frequencies, thread queue lengths, software bus queue lengths, or other factors or conditions in the mobile device to generate historical context information. As such, existing solutions also do not intelligently and dynamically determine whether to generate code for execution on the auxiliary processor based on a historical context of the mobile device. Existing solutions also do not determine whether to execute code previously complied for execution on an auxiliary processor, on the auxiliary processor, based the historical context of the mobile device.

The various aspects include mobile computing devices configured to make intelligent offloading decisions based on historical context information that identifies many such factors and conditions of the mobile computing device. The various aspects include methods of intelligently and dynamically offloading tasks from a general purpose processor to an auxiliary processor to realize greater power savings and improvements in performance than existing offloading solutions.

The various aspects enable a mobile device to make intelligent offloading decisions based on historical context information generated from monitoring the operating conditions of the device. Such historical context information may include thread queue lengths, software bus queue lengths, the operating states and frequencies of the processors, low power states of the resources used by the processors, the amount of time that the auxiliary processor has remained a low power state, the amount of time the auxiliary processor is expected to remain in an idle or low power state, the number of tasks scheduled for execution in the auxiliary processor, the latency associated with waking up the auxiliary processor, the latency associated with waking up the resources used by auxiliary processor, and other similar context information.

Various aspects may include multiprocessor mobile devices configured to make intelligent offloading decisions by collecting, generating, and using historical context information and/or information regarding the current states of both a local processor core (e.g., a CPU or applications processor) and a remote core or auxiliary processor (e.g., a DSP), and use the historical context information when making compilation, offloading, and execution decisions. In various aspects, the historical context information may be used by a processor of the multiprocessor device to intelligently determine whether a code segment can be offloaded to the remote core, whether that code segment should be compiled for execution on the remote core, and/or whether code that was previously compiled for execution on the remote core should actually be executed in the remote core or regenerated for execution in the local core.

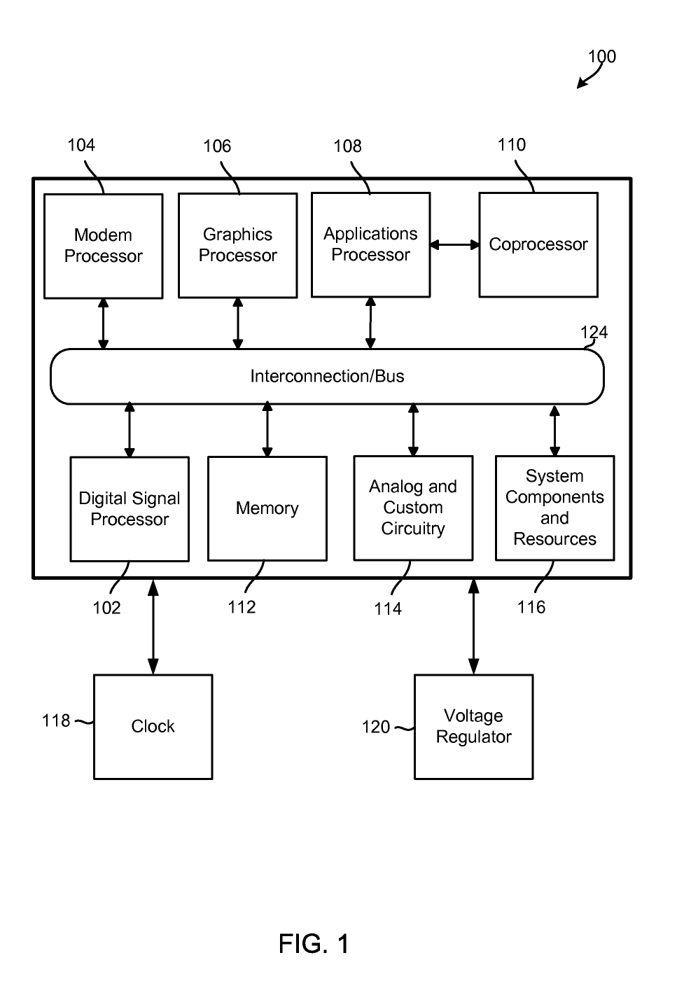

The various aspects may be implemented on a number of multiprocessor computer systems, including a system-on-chip (SOC). FIG. 1 illustrates an example system-on-chip (SOC) 100 architecture that may be used in computing devices implementing the various aspects. The SOC 100 may include a number of heterogeneous processors, such as a digital signal processor (DSP) 102, a modem processor 104, a graphics processor 106, and an application processor 108. The SOC 100 may also include one or more coprocessors 110 (e.g., vector co-processor, etc.) connected to one or more of the heterogeneous processors 102, 104, 106, 108. Each processor 102, 104, 106, 108, 110 may include one or more cores, and each processor/core may perform operations independent of the other processors/cores. For example, the SOC 100 may include a processor that executes a first type of operating system (e.g., FreeBSD, LINUX, OS X, etc.) and a processor that executes a second type of operating system (e.g., Microsoft® Windows 8).

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software clients (e.g., a web browser, etc.) running on a computing device.

The system components/resources 116 and custom circuitry 114 may also include circuitry to interface with peripheral devices, such as cameras, electronic displays, wireless communication devices, external memory chips, etc. The processors 102, 104, 106, 108 may be interconnected to each other and one or more memory elements 112, system components and resources 116 and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 102, a modem processor 104, a graphics processor 106, an application processor 108, etc.).

The processors 102, 104, 106, 108, 110 may be independent processing cores that are in close proximity (e.g., on a single substrate, die, integrated chip, etc.) to one another. The proximity of the processors 102, 104, 106, 108, 110 allows memory 112 to operate at a much higher frequency/clock-rate than is possible if the signals have to travel off-chip. Moreover, the proximity of the processors 102, 104, 106, 108, 110 allows for the sharing of on-chip memory and resources (e.g., voltage rail), as well as for more coordinated cooperation between cores.

Multiprocessor hardware designs, such as those discussed above with reference to FIG. 1, may include multiple processing cores of different capabilities inside the same package, often on the same piece of silicon. Symmetric multiprocessing hardware includes two or more identical processors that are connected to a single shared main memory and controlled by a single operating system. Asymmetric or “loosely-coupled” multiprocessing hardware may include two or more heterogeneous processors/cores that may each be controlled by an independent operating system and hardware description language or instruction set architecture, and connected to one or more shared memories/resources.

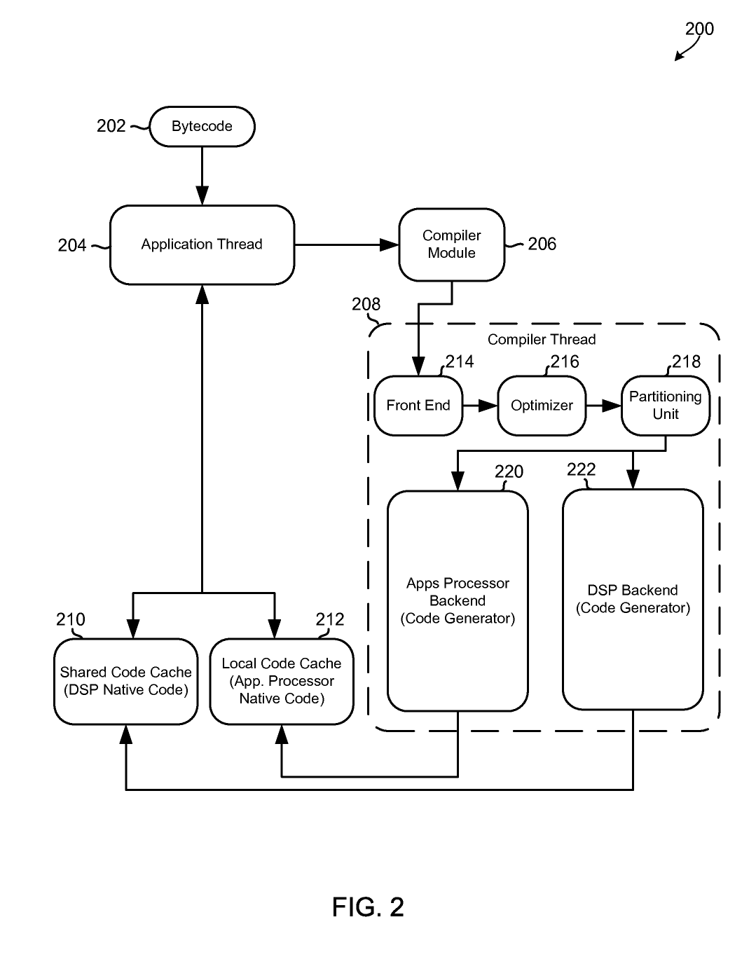

FIG. 2 illustrates example logical and functional components in an aspect multiprocessor computing system 200 configured to compile portions of a general purpose software application for execution in an auxiliary processor. The computer system 200 may include a bytecode module 202, an application thread module 204, a compiler module 206, a compiler thread module 208, a shared code cache module 210, and a local code cache module 212, any or all of which may be implemented in the user space of an operating system kernel.

The computing system 200 may also include various additional components configured to accomplish the functions of one or more of the modules 202-212, such as a host operating system, a guest operating system, a DSP operating system, library modules, software application programs, user processes, listener threads, execution hardware (e.g., an application processor, DSP, etc.), input/output devices, memories, etc. In an aspect, the computing system 200 may be configured to use virtualization techniques to improve the performance of the processors. Such virtualization techniques may be implemented in a hypervisor or a virtual machine, which is a software application that executes application programs like a physical hardware machine. For example, a virtual machine may provide an interface between application programs and the physical hardware, allowing application programs tied to a specific instruction set architecture (ISA) to execute on hardware implementing a different instruction set architecture.

Application developers generally write software applications as source code, which may be converted into compiled binary files or “bytecode” by a static offline compiler. The software application can then be distributed as bytecode (e.g., Dalvik bytecode) that specifies a virtual machine interface (e.g., Dalvik virtual machine). This allows the bytecode to be used by mobile devices having a wide variety of platforms and execution environments, so long as the receiving mobile devices include virtualization software that supports the virtual instruction set architecture (ISA) used by the static offline compiler to generate the bytecode.

In the example illustrated in FIG. 2, distribution bytecode (e.g., Dalvik bytecode) may be received in the bytecode module 202 and stored in a memory of the computing device 200 as a virtual memory image. The application thread module 204 may be configured to process and send the received bytecode to an interpreter or compiler module 206. The compiler module 206 and/or the compiler thread module 208 may compile, interpret, or translate the virtual ISA instructions into the actual ISA instructions that may be used by the underlying hardware. Thus, the compilation of the code may be performed in two steps, one before distribution and one after distribution. This allows the software applications to be easily ported to any computing device having virtualization software that supports the virtual ISA used by the first compiler, regardless of the device's underlying hardware and operating system interface.

The compiler thread module 208 may be configured to generate guest machine code and/or host machine code for direct execution on a guest or host platforms, operating systems, or hardware. For example, the compiler thread module 208 may be configured to compile the bytecode into DSP code suitable for direct execution in DSP and application code suitable for direct execution in a general purpose applications processor.

The compiler thread module 208 may include a compiler front end module 214, a compiler optimizer module 216, a compiler partitioning unit module 218, an applications processor backend module 220, and a DSP backend module 222. The compiler front end module 214 may be configured to receive the bytecode from the compiler module 206, and perform type checking operations, check the code's syntax and semantics, and generate an intermediate representation (“intermediate code”) of the bytecode. The compiler optimizer 216 module may perform various operations for optimizing the generated intermediate code, such as removing useless or unreachable code, relocating computations, and other similar optimization operations.

The compiler partitioning unit module 218 may be configured to analyze the optimized intermediate code, partition the intermediate code into code portions and determine whether an auxiliary processor (e.g., DSP) may be used to execute the code portions. In the illustrated example of FIG. 2, the compiler partitioning unit module 218 may determine that a DSP may be used to execute some of the code portions, route the code portions that may be executed on the DSP to the DSP backend module 222, and route the remaining code portions to the applications processor backend module 220.

Each of the compiler back-end modules 220, 222 may be configured to compile and/or translate the optimized intermediate code to generate binary/object code that encodes the specific machine instructions that will be executed by a specific combination of hardware and/or software. For example, when the compiler partitioning unit module 218 determines that a code segment can be executed or processed in a DSP, that portion of the code may be sent to the DSP backend module 222, and the DSP backend module 222 may compile, translate or regenerate the code portions in a native code format that is suitable for execution in the DSP. As part of this code generation process, the DSP backend module 222 may add pointers, links, and process control instructions into the code. This enables the native code to be executed in the DSP in a manner that accomplishes the same functions or operations as would be accomplished if the code were executed in the general purpose applications processor.

The native code generated by the compiler back-end modules 220, 222 may be stored in a physical memory so that it may be retrieved by a loader process or application as an executable image. For example, native code generated by the applications processor backend module 220 may be stored in a first memory via the local code cache module 212, and the native code generated by the DSP backend module 222 may be stored in a second memory via the shared code cache module 210. The loader process may retrieve the code from the first memory and load the code for execution in the general purpose applications processor. Similarly, the loader process may pull the native code from the second memory and load the code for execution in the DSP.

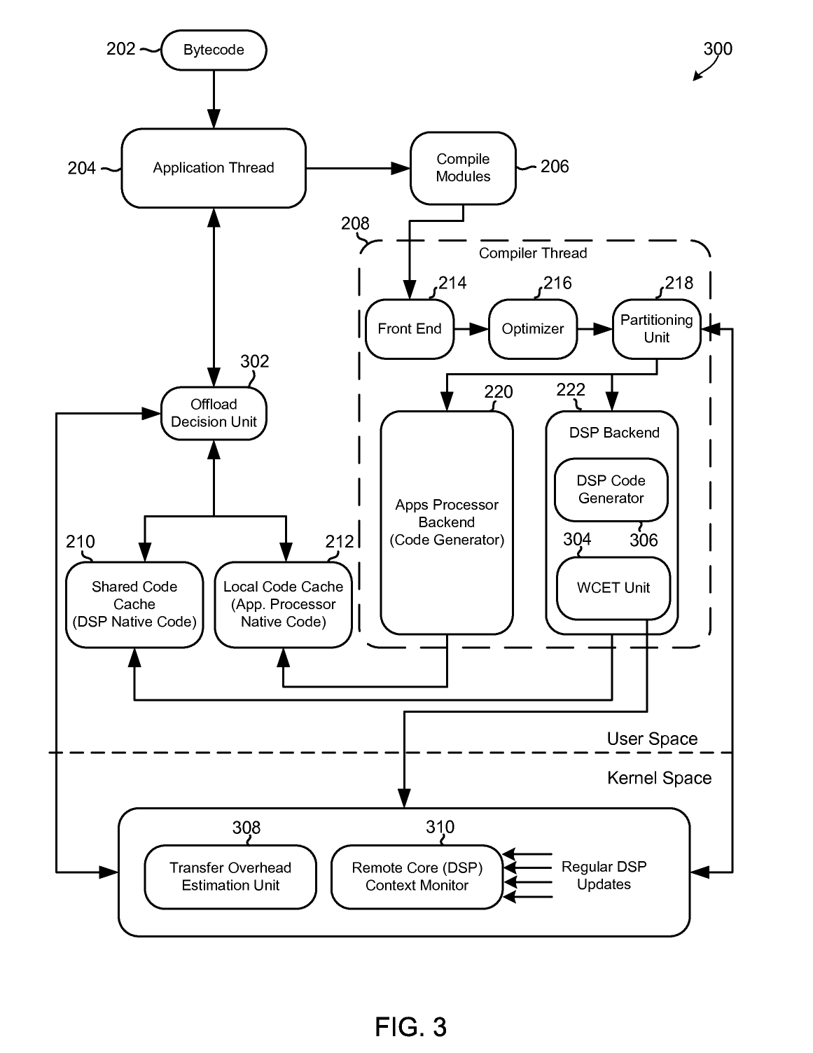

FIG. 3 illustrates example logical and functional components in an aspect multiprocessor computing system 300 configured to collect historical context information and compile portions of a general purpose application for execution on an auxiliary processor (e.g., a DSP) based on the collected historical context information. The illustrated computing system 300 includes all of the components of the computing system 200 discussed above with respect to FIG. 2. In addition, the computing system 300 may include an offload decision unit 302 module, worst case estimation (WCET) unit 304 module, a DSP code generator module 306, a transfer overhead estimation unit 308 module, and a remote core context monitor module 310.

In an aspect, the WCET unit 304 and DSP code generator modules 306 may be included in the DSP backend module 222 in the user space of the operating system kernel. In an aspect, the offload decision unit module 302 may be included in the user space of the operating system kernel. In an aspect, the transfer overhead estimation unit module 308 and the remote core context monitor module 310 may be included in the kernel space of the operating system kernel. In an aspect, all or portions of the remote core context monitor module 310 may be implemented in the user space of the kernel.

Any or all of the WCET unit 304, transfer overhead estimation unit module 308, and remote core context monitor module 310 may be configured to collect historical context information by monitoring any of a variety of operating conditions, frequencies, states, and/or latencies in the computing system 300.

The remote core context monitor module 310 may be configured to receive context updates from a DSP of the computing system 300. As part of these updates, the remote core context monitor module 310 may receive a current task list that identifies all the processes, threads, or tasks that are in the run queue of the DSP and/or in the run queue of the general purpose applications processor. Also as part of these updates, remote core context monitor module 310 may receive worst case estimates for the performance of the operations and/or the execution of code segments that the compiler thread module 208 previously determined to be suitable for offloading to the DSP. In addition, the remote core context monitor module 310 may receive or collect updated power management information, power state information, operating state information, operating frequency information, latency information, software bus information, scheduler information, and/or other information that is suitable for use in determining the overall status, state, condition and/or historical context of the DSP, the applications processor, resources, or the computing system 300 as a whole.

The remote core context monitor module 310 may be configured to receive, collect, and store the context information, and generate historical context information that describes a plurality of past, current, and predicted future mobile device operating conditions in a succinct yet comprehensive data structure or communication message. The remote core context monitor module 310 may send the generated structure/message and/or the received or collected context information to any or all of the transfer overhead estimation unit module 308, the compiler partitioning unit module 218, and the offload decision unit module 302.

The transfer overhead estimation unit module 308 may be configured to receive context information from the remote core context monitor module 310, and use this information to compute wait times, latencies, execution times, and other values that are indicative of the benefits and/or costs of offloading a code segment to the DSP. For example, the transfer overhead estimation unit module 308 may be configured to compute the amount of power required to compile and execute a code segment in the DSP, and compare this computed power value to the amount of power that would be consumed if that code segment were executed in the application processor at its current operating frequency. As another example, the transfer overhead estimation unit module 308 may compute the total amount of time that it would take to offload the code segment to the DSP based on the length of the DSP run queue, and compare that time value to the amount of time required to execute that code segment in the applications process and/or to the performance and responsiveness requirements of the computing device.

Based on such calculations, transfer overhead estimation unit module 308 may cause or instruct the compiler partitioning unit module 218 and/or the offload decision unit module 302 to not compile the code segment for execution in the DSP or to not execute in the DSP previously compiled code stored in the shared code cache module 210 that corresponds to that code segment. The transfer overhead estimation unit module 308 may also update the historical context information to include these computations, and send the updated historical information to the compiler partitioning unit module 218 and/or the offload decision unit module 302.

The offload decision unit module 302 may be configured to receive the historical context information and determine whether to compile other portions of the software application into code suitable for execution in the DSP. The offload decision unit module 302 may also use the historical information to determine whether the portions of the general purpose software application that were previously determined to be suitable for execution in DSP by the compiler partitioning unit module 218 should be actually be compiled for execution in the DSP. The offload decision unit module 302 may further use the historical information to determine whether the portions of the software application that were compiled into code suitable for execution in the DSP should actually be executed in the DSP. The offload decision unit module 302 may communicate the results of its analysis to the application thread module 204, shared code cache module 210, local code cache module 212, and/or various other components in the kernel space to cause the computing system 300 to perform operations that are consistent with the offloading determinations made in the offload decision unit module 302.

In an aspect, the computing system 300 may be configured to monitor in the main applications processor the auxiliary processor's state and schedule changes or updates. Such updates may include information suitable for determining the DSP's response time, workload, power state, etc. Examples of such information include idle frequency/status, current operations rate (MIPS), a depth of an input or output buffer, operations, buses, execution queue depth, power state, etc. These changes/updates may be propagated to the general purpose applications processor at regular intervals or in response to a component in the computing system 300 detecting the occurrence of an important event, including a return from interrupt, task preemption, scheduling of new task, etc. The system may make offloading decisions at both the compile time (e.g., determining not to generate the code because the DSP is going to be busy) and runtime (e.g., determining not to invoke the generated code because the DSP is currently too busy). In an aspect, the code may be compiled dynamically and at runtime, so that the compile time is the same as runtime.

The benefits of executing portions of a general purpose software application on an auxiliary processor (e.g., a DSP) are highly dependent on the current overall conditions of the computing system 300. By collecting information from many different components, layers, modules and subsystems of the computing device to generate historical context information, and by using such information to make intelligent compilation and offloading decisions, the various aspects may significantly improve the performance and power consumption characteristics of the computing system 300.

Various aspects may include components configured to monitor the current state or characteristics of the auxiliary processors and use this information when making offloading decisions.

Various aspects may include components configured to determine whether to compile, translate, or interpret software application code for execution in an auxiliary processor based on the current state of the computing device, or any combination of its processors and resources.

Various aspects may include components configured to determine to invoke a code unit of the software application code that has been compiled, translated, or interpreted for execution on the auxiliary processor to execute on that auxiliary processor based on the current state of the mobile device, or any combination of its processors and resources.

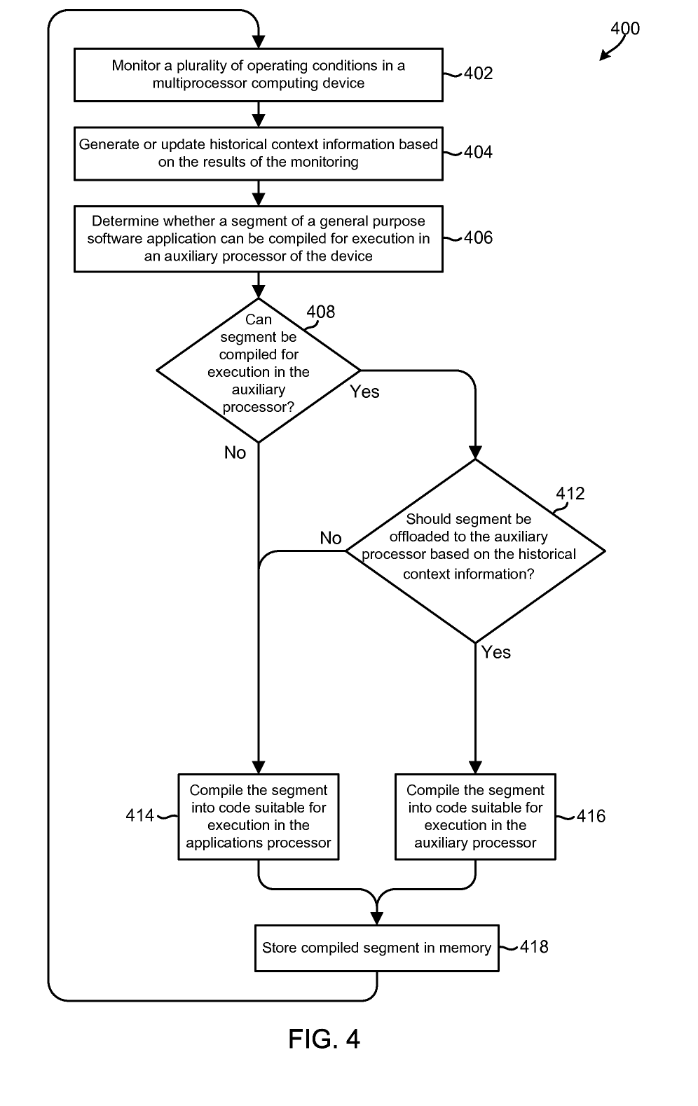

FIG. 4 illustrates an aspect method 400 of compiling portions of a general purpose software application for execution in an auxiliary processor of a multiprocessor device. In block 402, an application processor or CPU of the multiprocessor device may monitor a plurality of operating factors and conditions of the device. Such factors and conditions may include the current power state of an auxiliary processor of the multiprocessor device, the amount of time the auxiliary processor has remained in its current power state, the amount of time required to cause the auxiliary processor exit its current low power mode (e.g., its exit latency), an execution history of the auxiliary processor, historical information regarding tasks scheduled for execution in the auxiliary processor, historical power state and operating frequency information of the auxiliary processor, the current operating frequency of the auxiliary processor, the length of run queue of the auxiliary processor (e.g., number of tasks waiting for execution, etc.), and other factors suitable for predicting the amount of time that the auxiliary processor will remain in its power state (e.g., workload, etc.). Additional factors and conditions that may be monitored in block 402 include the power state of the application processor, the operating frequency of the application processor, the length of the application processor's run queue, power states of various resources used by these processors, the latencies of these resources, etc. In an aspect, the applications processor may store the results of the monitoring in a memory of the multiprocessor device.

In block 404, the applications processor may generate or update historical context information based on the results of the monitoring operations performed in block 402. The applications processor may determine whether a segment of a general purpose software application can be compiled for execution in the auxiliary processor in block 406, and determine whether the multiprocessor computing device includes auxiliary processor capable of executing that segment determination block 408.

When the applications processor determines that the segment cannot be compiled for execution in the auxiliary processor (i.e., determination block 408=“No”), the application processor may compile the segment into code that is suitable for execution in the application processor in block 414. In block 418, the applications processor may store the compiled segment in a memory of the multiprocessor device, and continue monitoring the operating conditions of the device in block 402.

When the applications processor determines that the segment can be compiled for execution in the auxiliary processor (i.e., determination block 408=“Yes”), the application processor may determine whether that segment should be offloaded to the auxiliary processor based on the historical context information in determination block 412. For example, the applications process may determine whether improvements in performance or power consumption will be achieved by executing that segment in the auxiliary processor (as opposed to the applications processor) based on the historical information, which may include information relating to an execution history of the auxiliary processor, historical information regarding tasks scheduled for execution in the auxiliary processor, historical power state and operating frequency information of the auxiliary processor, number of tasks scheduled for execution in the auxiliary processor, a current power state of the auxiliary processor, a current operating frequency of the auxiliary processor, or other similar information.

When the applications processor determines that the segment should be offloaded to the auxiliary processor (i.e., determination block 412=“Yes”), the application processor may compile the segment into code that is suitable for execution in the auxiliary processor in block 416. In block 418, the applications processor may store the compiled segment in a memory of the multiprocessor device, and continue monitoring the operating conditions of the device in block 402.

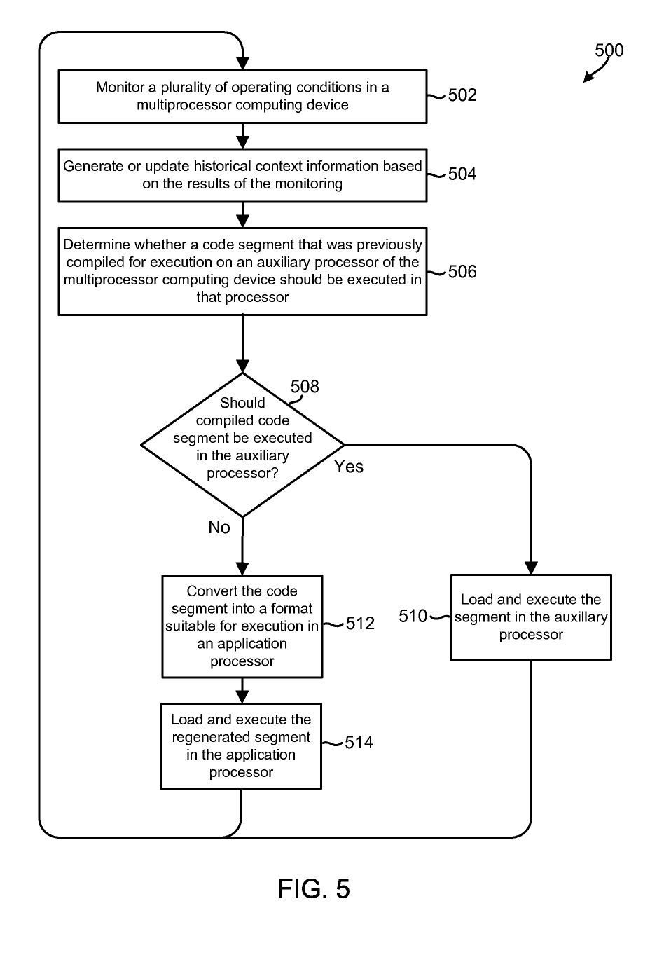

FIG. 5 illustrates an aspect method 500 of executing previously compiled portions of a general purpose software application in multiprocessor computing device. In an aspect, the operations of method 500 may be performed after the operations in block 418 of method 400 described above. In an aspect, the operations of method 500 may be performed in parallel with the operations of method 400.

In block 502, an application processor or CPU of the multiprocessor device may monitor a plurality of operating factors and conditions of the device, such as those discussed above. In block 504, the applications processor may generate or update historical context information based on the results of the monitoring operations. In block 506, the applications processor may determine whether a code segment previously compiled for execution on the auxiliary processor should be executed in that processor, and decide whether to execute the code in the auxiliary processor or applications processor in determination block 508. For example, the applications process may determine whether improvements in performance or power consumption will be achieved by executing that segment in the auxiliary processor (as opposed to the applications processor) based on the current power state and operating frequency of the auxiliary processor.

When the applications processor decides that the previously compiled code segment should be executed in the auxiliary processor (i.e., determination block 508=“Yes”), in block 510, the application processor may load the compiled code segment for execution in the auxiliary processor or perform other operations to cause or allow the auxiliary processor to execute the code segment. The applications processor may repeat these processes by returning to monitor the operating conditions of the device in block 502.

When the applications processor determines that the previously compiled code segment should not be executed in the auxiliary processor (i.e., determination block 508=“No”), in block 512, the applications processor may recompile, translate, regenerate, or otherwise convent the compiled code segment into a format that is suitable for execution in the applications processor. In block 514, the applications processor may load and execute the segment, and repeat these processes by returning to monitor the operating conditions of the device in block 502.

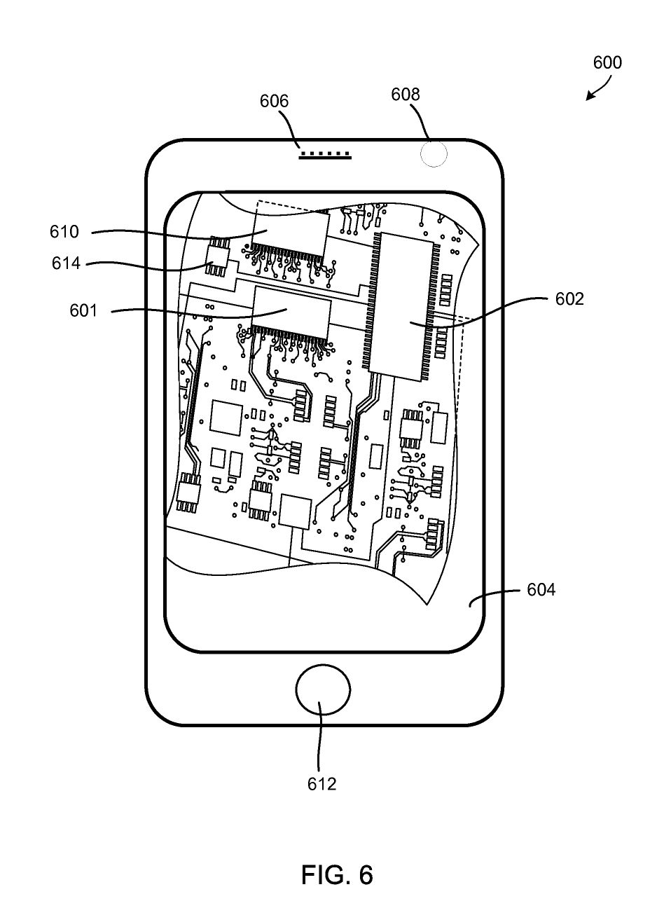

The various aspects may be implemented on a variety of computing devices, examples of which are illustrated in FIGS. 6-8. FIG. 6 illustrates a smartphone 600 that includes a multi-core processor 601 coupled to internal memory 602, a display 604 (e.g., touch screen display), and to a speaker 606. Additionally, the smartphone 600 may include an antenna 608 for sending and receiving electromagnetic radiation that may be connected to a wireless data link and/or a modem or cellular telephone transceiver 610 coupled to the multi-core processor 601. A smartphone 600 typically also includes menu selection buttons or rocker switches 612 for receiving user inputs.

The multi-core processor 601 may include circuits and structures similar to those described above and illustrated in FIG. 1, and include any or all of the logical or functional components illustrated in FIGS. 2 and 3. The modem 601 may also include multiple processing cores, and may be coupled to an antenna 608 for receiving and transmitting radio frequency signals.

A typical smartphone 600 also includes a sound encoding/decoding (CODEC) circuit 614, which digitizes sound received from a microphone into data packets suitable for wireless transmission and decodes received sound data packets to generate analog signals that are provided to the speaker to generate sound. Also, one or more of the multi-core processor 601, wireless transceiver 610 and CODEC 614 may include a digital signal processor (DSP) circuit (not shown separately).

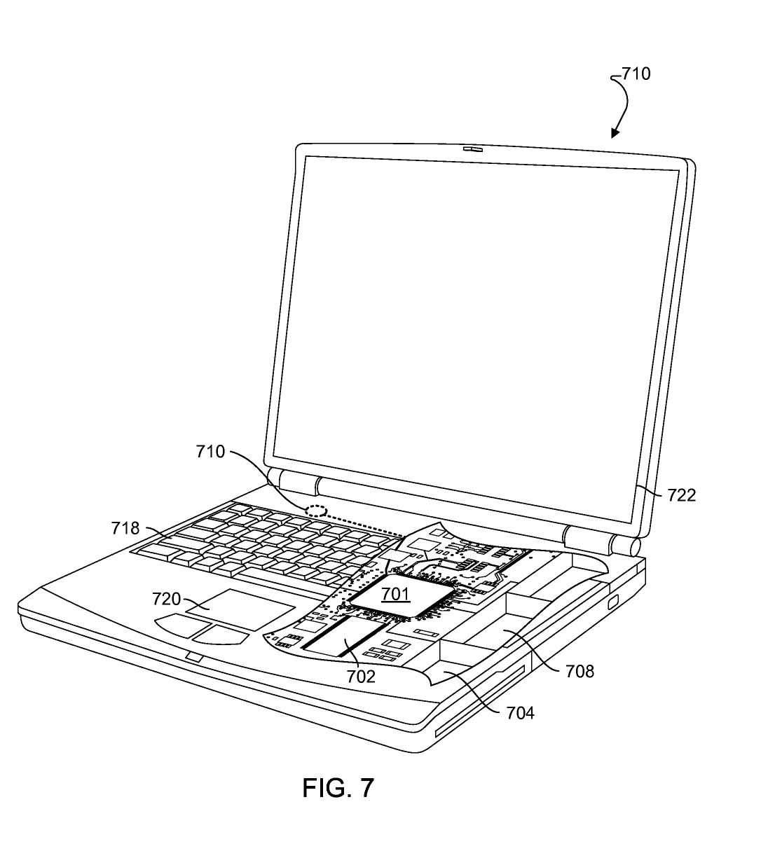

Typical mobile computing devices will have in common the components illustrated in FIG. 7, which illustrates an example personal laptop computer 700. Such a personal computer 700 generally includes a multi-core processor 701 coupled to volatile memory 702 and a large capacity nonvolatile memory, such as a disk drive 704. The computer 700 may also include a compact disc (CD) and/or DVD drive 708 coupled to the processor 701. The computer device 700 may also include a number of connector ports coupled to the processor 701 for establishing data connections or receiving external memory devices, such as a network connection circuit for coupling the processor 701 to a network. The computing device 700 may have a radio/antenna 710 for sending and receiving electromagnetic radiation that is connected to a wireless data link coupled to the processor 701. The computer 700 may further include keyboard 718, a pointing a mouse pad 720, and a display 722 as is well known in the computer arts.

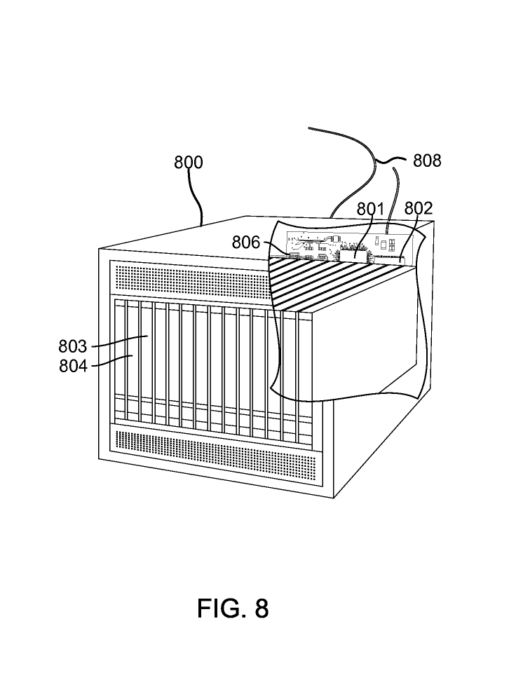

The various aspects may also be implemented on any of a variety of commercially available server devices, such as the server 800 illustrated in FIG. 8. Such a server 800 typically includes multiple processor systems one or more of which may be or include a multi-core processor 801. The processor 801 may be coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing data connections with a network 808, such as a local area network coupled to other broadcast system computers and servers.

The processors 601, 701, 801 may be any programmable multi-core multiprocessor, microcomputer or multiple processor chips that can be configured by software instructions (applications) to perform a variety of functions, including the functions and operations of the various aspects described herein. Multiple processors may be provided, such as one processor dedicated to wireless communication functions and one processor dedicated to running other applications. Typically, software applications may be stored in the internal memory 602, 702, 802 before they are accessed and loaded into the processor 601, 701, 801. In some mobile computing devices, additional memory chips (e.g., a Secure Data (SD) card) may be plugged into the mobile device and coupled to the processor 601, 701, 801. The internal memory 602, 702, 802 may be a volatile or nonvolatile memory, such as flash memory, or a mixture of both. For the purposes of this description, a general reference to memory refers to all memory accessible by the processor 601, 701, 801, including internal memory 602, 702, 802, removable memory plugged into the mobile device, and memory within the processor 601, 701, 801 itself.

Computer program code or “code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used herein refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space is not required be GPL licensed. It should be understood that the various software components/modules discussed here may be implemented in either the kernel space or the user space, unless expressly stated otherwise.

As used in this application, the terms “component,” “module,” “system,” “service,” “engine,” “listener,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core, and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The foregoing method descriptions and the process flow diagrams are provided merely as illustrative examples and are not intended to require or imply that the blocks of the various aspects must be performed in the order presented. As will be appreciated by one of skill in the art the order of blocks in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of offloading portions of a general purpose software application to an auxiliary processor of a multiprocessor computing device, comprising:
monitoring in an application processor a plurality of operating conditions of the multiprocessor computing device;
generating historical context information based on the monitoring;
determining whether a segment of the general purpose software application can be compiled for execution in the auxiliary processor;
determining whether the segment should be offloaded to the auxiliary processor based on the historical context information in response to determining that the segment can compiled for execution in the auxiliary processor; and
compiling the segment of the general purpose software application into code suitable for execution in the auxiliary processor in response to determining that the segment should be offloaded.

2. The method of claim 1, further comprising:
continuing to monitor the plurality of operating conditions of the multiprocessor computing device;
updating the historical context information based on the continued monitoring;
determining whether the compiled segment should be executed in the auxiliary processor based on the updated historical context information;
executing the compiled segment in the auxiliary processor when the updated historical context information indicates that the compiled segment should be executed in the auxiliary processor; and
compiling and executing the segment of the general purpose software application in the application processor when the updated historical context information indicates that the compiled segment should not be executed in the auxiliary processor.

3. The method of claim 1, wherein determining whether the segment should be offloaded to the auxiliary processor based on the historical context information comprises determining whether the segment should be offloaded to the auxiliary processor based on an execution history of the auxiliary processor.

4. The method of claim 3, wherein determining whether the segment should be offloaded to the auxiliary processor based on the execution history of the auxiliary processor comprises determining whether the segment should be offloaded to the auxiliary processor based on historical information regarding tasks scheduled for execution in the auxiliary processor.

5. The method of claim 1, wherein determining whether the segment should be offloaded to the auxiliary processor based on the historical context information comprises determining whether the segment should be offloaded to the auxiliary processor based on historical power state and operating frequency information of the auxiliary processor.

6. The method of claim 2, wherein:
determining whether the compiled segment should be executed in the auxiliary processor based on the updated historical context information comprises determining whether improvements in performance or power consumption will be achieved by executing the segment in the auxiliary processor based on an execution history of the auxiliary processor; and
executing the compiled segment in the auxiliary processor when the updated historical context information indicates that the compiled segment should be executed in the auxiliary processor comprises executing the compiled segment only when the updated historical context information indicates that improvements in performance or power consumption will be achieved by executing the compiled segment in the auxiliary processor.

7. The method of claim 1, wherein:
monitoring the plurality of operating conditions of the multiprocessor computing device comprises monitoring a number of tasks scheduled for execution in the auxiliary processor, a current power state of the auxiliary processor, and an operating frequency of the auxiliary processor;
determining whether the segment should be offloaded to the auxiliary processor based on the historical context information comprises determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor; and
compiling the segment of the general purpose software application into code suitable for execution in the auxiliary processor in response to determining that the segment should be offloaded comprises compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

8. The method of claim 1, wherein determining whether the segment of the general purpose software application can be compiled for execution in the auxiliary processor comprises:
analyzing the general purpose software application to identify operations that are required to be performed during its execution;
partitioning the general purpose software application into code units based on identified operations; and
determining whether the auxiliary processor is capable of performing the identified operations.

9. The method of claim 1, wherein determining whether the segment of the general purpose software application can be compiled for execution in the auxiliary processor comprises determining whether the segment can be compiled for execution in a digital signal processor.

10. The method of claim 1, wherein monitoring the plurality of operating conditions of the multiprocessor computing device comprises monitoring two or more of:
a power state of the auxiliary processor;
an amount of time the auxiliary processor has remained in its current power state;
a predicted amount of time that the auxiliary processor will remain in its current power state;
an amount of time required to cause the auxiliary processor to exit its current power state;
an operating frequency of the auxiliary processor;
a run queue of the auxiliary processor;
a power state of the application processor;
an operating frequency of the application processor;
a run queue of the application processor; and
a power state of a resource in the multiprocessor computing device.

11. A multiprocessor computing device, comprising:
means for monitoring in an application processor a plurality of operating conditions;
means for generating historical context information based on the monitoring;
means for determining whether a segment of a general purpose software application can be compiled for execution in an auxiliary processor of the multiprocessor computing device;
means for determining whether the segment should be offloaded to the auxiliary processor based on the historical context information and in response to determining that the segment can compiled for execution in the auxiliary processor; and
means for compiling the segment of the general purpose software application into code suitable for execution in the auxiliary processor in response to determining that the segment should be offloaded.

12. The multiprocessor computing device of claim 11, further comprising:
means for continuing to monitor the plurality of operating conditions;
means for updating the historical context information based on the continued monitoring;
means for determining whether the compiled segment should be executed in the auxiliary processor based on the updated historical context information;
means for executing the compiled segment in the auxiliary processor when the updated historical context information indicates that the compiled segment should be executed in the auxiliary processor; and
means for compiling and executing the segment of the general purpose software application in the application processor when the updated historical context information indicates that the compiled segment should not be executed in the auxiliary processor.

13. The multiprocessor computing device of claim 11, wherein means for determining whether the segment should be offloaded to the auxiliary processor based on the historical context information comprises means for determining whether the segment should be offloaded to the auxiliary processor based on an execution history of the auxiliary processor.

14. The multiprocessor computing device of claim 13, wherein means for determining whether the segment should be offloaded to the auxiliary processor based on the execution history of the auxiliary processor comprises means for determining whether the segment should be offloaded to the auxiliary processor based on historical information regarding tasks scheduled for execution in the auxiliary processor.

15. The multiprocessor computing device of claim 11, wherein means for determining whether the segment should be offloaded to the auxiliary processor based on the historical context information comprises means for determining whether the segment should be offloaded to the auxiliary processor based on historical power state and operating frequency information of the auxiliary processor.

16. The multiprocessor computing device of claim 12, wherein:
means for determining whether the compiled segment should be executed in the auxiliary processor based on the updated historical context information comprises means for determining whether improvements in performance or power consumption will be achieved by executing the segment in the auxiliary processor based on an execution history of the auxiliary processor; and
means for executing the compiled segment in the auxiliary processor when the updated historical context information indicates that the compiled segment should be executed in the auxiliary processor comprises means for executing the compiled segment only when the updated historical context information indicates that improvements in performance or power consumption will be achieved by executing the compiled segment in the auxiliary processor.

17. The multiprocessor computing device of claim 11, wherein:
means for monitoring the plurality of operating conditions comprises means for monitoring a number of tasks scheduled for execution in the auxiliary processor, a current power state of the auxiliary processor, and an operating frequency of the auxiliary processor;
means for determining whether the segment should be offloaded to the auxiliary processor based on the historical context information comprises means for determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor; and
means for compiling the segment of the general purpose software application into code suitable for execution in the auxiliary processor in response to determining that the segment should be offloaded comprises means for compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

18. The multiprocessor computing device of claim 11, wherein means for determining whether the segment of the general purpose software application can be compiled for execution in the auxiliary processor comprises:
means for analyzing the general purpose software application to identify operations that are required to be performed during its execution;
means for partitioning the general purpose software application into code units based on identified operations; and
means for determining whether the auxiliary processor is capable of performing the identified operations.

19. The multiprocessor computing device of claim 11, wherein means for determining whether the segment of the general purpose software application can be compiled for execution in the auxiliary processor comprises means for determining whether the segment can be compiled for execution in a digital signal processor.

20. The multiprocessor computing device of claim 11, wherein means for monitoring the plurality of operating conditions comprises means for monitoring two or more of:
a power state of the auxiliary processor;
an amount of time the auxiliary processor has remained in its current power state;
a predicted amount of time that the auxiliary processor will remain in its current power state;
an amount of time required to cause the auxiliary processor to exit its current power state;
an operating frequency of the auxiliary processor;
a run queue of the auxiliary processor;
a power state of the application processor;
an operating frequency of the application processor;
a run queue of the application processor; and
a power state of a resource in the multiprocessor computing device.

21. A multiprocessor computing device, comprising:
an application processor; and
an auxiliary processor coupled to the application processor, wherein the application processor is configured with processor-executable instructions to perform operations comprising:
monitoring a plurality of operating conditions;
generating historical context information based on the monitoring;
determining whether a segment of a general purpose software application can be compiled for execution in the auxiliary processor;
determining whether the segment should be offloaded to the auxiliary processor based on the historical context information and in response to determining that the segment can compiled for execution in the auxiliary processor; and
compiling the segment of the general purpose software application into code suitable for execution in the auxiliary processor in response to determining that the segment should be offloaded.

22. The multiprocessor computing device of claim 21, wherein the application processor is configured with processor-executable instructions to perform operations further comprising:
continuing to monitor the plurality of operating conditions;
updating the historical context information based on the continued monitoring;
determining whether the compiled segment should be executed in the auxiliary processor based on the updated historical context information;
causing the auxiliary processor to execute the compiled segment when the updated historical context information indicates that the compiled segment should be executed in the auxiliary processor; and
compiling and executing the segment of the general purpose software application in the application processor when the updated historical context information indicates that the compiled segment should not be executed in the auxiliary processor.

23. The multiprocessor computing device of claim 21, wherein the application processor is configured with processor-executable instructions to perform operations such that determining whether the segment should be offloaded to the auxiliary processor based on the historical context information comprises determining whether the segment should be offloaded to the auxiliary processor based on an execution history of the auxiliary processor.

24. The multiprocessor computing device of claim 23, wherein the application processor is configured with processor-executable instructions to perform operations such that determining whether the segment should be offloaded to the auxiliary processor based on the execution history of the auxiliary processor comprises determining whether the segment should be offloaded to the auxiliary processor based on historical information regarding tasks scheduled for execution in the auxiliary processor.

25. The multiprocessor computing device of claim 21, wherein the application processor is configured with processor-executable instructions to perform operations such that determining whether the segment should be offloaded to the auxiliary processor based on the historical context information comprises determining whether the segment should be offloaded to the auxiliary processor based on historical power state and operating frequency information of the auxiliary processor.

26. The multiprocessor computing device of claim 22, wherein the application processor is configured with processor-executable instructions to perform operations such that:
determining whether the compiled segment should be executed in the auxiliary processor based on the updated historical context information comprises determining whether improvements in performance or power consumption will be achieved by executing the segment in the auxiliary processor based on an execution history of the auxiliary processor; and
executing the compiled segment in the auxiliary processor when the updated historical context information indicates that the compiled segment should be executed in the auxiliary processor comprises executing the compiled segment only when the updated historical context information indicates that improvements in performance or power consumption will be achieved by executing the compiled segment in the auxiliary processor.

27. The multiprocessor computing device of claim 21, wherein the application processor is configured with processor-executable instructions to perform operations such that:
monitoring the plurality of operating conditions comprises monitoring a number of tasks scheduled for execution in the auxiliary processor, a current power state of the auxiliary processor, and an operating frequency of the auxiliary processor;
determining whether the segment should be offloaded to the auxiliary processor based on the historical context information comprises determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor; and
compiling the segment of the general purpose software application into code suitable for execution in the auxiliary processor in response to determining that the segment should be offloaded comprises compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

28. The multiprocessor computing device of claim 21, wherein the application processor is configured with processor-executable instructions to perform operations such that determining whether the segment of the general purpose software application can be compiled for execution in the auxiliary processor comprises:
analyzing the general purpose software application to identify operations that are required to be performed during its execution;
partitioning the general purpose software application into code units based on identified operations; and
determining whether the auxiliary processor is capable of performing the identified operations.

29. The multiprocessor computing device of claim 21, wherein the application processor is configured with processor-executable instructions to perform operations such that determining whether the segment of the general purpose software application can be compiled for execution in the auxiliary processor comprises determining whether the segment can be compiled for execution in a digital signal processor.

30. The multiprocessor computing device of claim 21, wherein the application processor is configured with processor-executable instructions to perform operations such that monitoring the plurality of operating conditions of the multiprocessor computing device comprises monitoring two or more of:
a power state of the auxiliary processor;
an amount of time the auxiliary processor has remained in its current power state;
a predicted amount of time that the auxiliary processor will remain in its current power state;
an amount of time required to cause the auxiliary processor to exit its current power state;
an operating frequency of the auxiliary processor;
a run queue of the auxiliary processor;
a power state of the application processor;
an operating frequency of the application processor;
a run queue of the application processor; and
a power state of a resource in the multiprocessor computing device.

31. A non-transitory computer readable storage medium having stored thereon processor-executable software instructions configured to cause an application processor of a multiprocessor computing device to perform operations for offloading portions of a general purpose software application to an auxiliary processor of the multiprocessor computing device, the operations comprising:
monitoring a plurality of operating conditions;
generating historical context information based on the monitoring;
determining whether a segment of the general purpose software application can be compiled for execution in the auxiliary processor;
determining whether the segment should be offloaded to the auxiliary processor based on the historical context information and in response to determining that the segment can compiled for execution in the auxiliary processor; and
compiling the segment of the general purpose software application into code suitable for execution in the auxiliary processor in response to determining that the segment should be offloaded.

32. The non-transitory computer readable storage medium of claim 31, wherein the stored processor-executable software instructions are configured to cause the application processor to perform operations further comprising:
continuing to monitor the plurality of operating conditions;
updating the historical context information based on the continued monitoring;
determining whether the compiled segment should be executed in the auxiliary processor based on the updated historical context information;
causing the auxiliary processor to execute the compiled segment when the updated historical context information indicates that the compiled segment should be executed in the auxiliary processor; and
compiling and executing the segment of the general purpose software application in the application processor when the updated historical context information indicates that the compiled segment should not be executed in the auxiliary processor.

33. The non-transitory computer readable storage medium of claim 31, wherein the stored processor-executable software instructions are configured to cause the application processor to perform operations such that determining whether the segment should be offloaded to the auxiliary processor based on the historical context information comprises determining whether the segment should be offloaded to the auxiliary processor based on an execution history of the auxiliary processor.

34. The non-transitory computer readable storage medium of claim 33, wherein the stored processor-executable software instructions are configured to cause the application processor to perform operations such that determining whether the segment should be offloaded to the auxiliary processor based on the execution history of the auxiliary processor comprises determining whether the segment should be offloaded to the auxiliary processor based on historical information regarding tasks scheduled for execution in the auxiliary processor.

35. The non-transitory computer readable storage medium of claim 31, wherein the stored processor-executable software instructions are configured to cause the application processor to perform operations such that determining whether the segment should be offloaded to the auxiliary processor based on the historical context information comprises determining whether the segment should be offloaded to the auxiliary processor based on historical power state and operating frequency information of the auxiliary processor.

36. The non-transitory computer readable storage medium of claim 32, wherein the stored processor-executable software instructions are configured to cause the application processor to perform operations such that:
determining whether the compiled segment should be executed in the auxiliary processor based on the updated historical context information comprises determining whether improvements in performance or power consumption will be achieved by executing the segment in the auxiliary processor based on an execution history of the auxiliary processor; and
executing the compiled segment in the auxiliary processor when the updated historical context information indicates that the compiled segment should be executed in the auxiliary processor comprises executing the compiled segment only when the updated historical context information indicates that improvements in performance or power consumption will be achieved by executing the compiled segment in the auxiliary processor.

37. The non-transitory computer readable storage medium of claim 31, wherein the stored processor-executable software instructions are configured to cause the application processor to perform operations such that:
monitoring the plurality of operating conditions of the multiprocessor computing device comprises monitoring a number of tasks scheduled for execution in the auxiliary processor, a current power state of the auxiliary processor, and an operating frequency of the auxiliary processor;
determining whether the segment should be offloaded to the auxiliary processor based on the historical context information comprises determining whether improvements in performance or power consumption will be achieved by executing the segment in the auxiliary processor based on the number of tasks scheduled for execution in the auxiliary processor, the current power state of the auxiliary processor, and the operating frequency of the auxiliary processor; and
compiling the segment of the general purpose software application into code suitable for execution in the auxiliary processor in response to determining that the segment should be offloaded comprises compiling the segment into code suitable for execution in the auxiliary processor only when the historical context information indicates that the number of tasks scheduled for execution in the auxiliary processor, the current power state of the auxiliary processor and the operating frequency of the auxiliary processor are such that improvements in performance or power consumption will be achieved by offloading the segment for execution in the auxiliary processor.

38. The non-transitory computer readable storage medium of claim 31, wherein the stored processor-executable software instructions are configured to cause the application processor to perform operations such that determining whether the segment of the general purpose software application can be compiled for execution in the auxiliary processor comprises:
analyzing the general purpose software application to identify operations that are required to be performed during its execution;
partitioning the general purpose software application into code units based on identified operations; and
determining whether the auxiliary processor is capable of performing the identified operations.

39. The non-transitory computer readable storage medium of claim 31, wherein the stored processor-executable software instructions are configured to cause the application processor to perform operations such that determining whether the segment of the general purpose software application can be compiled for execution in the auxiliary processor comprises determining whether the segment can be compiled for execution in a digital signal processor.

40. The non-transitory computer readable storage medium of claim 31, wherein the stored processor-executable software instructions are configured to cause the application processor to perform operations such that monitoring the plurality of operating conditions of the multiprocessor computing device comprises monitoring two or more of:
a power state of the auxiliary processor;
an amount of time the auxiliary processor has remained in its current power state;
a predicted amount of time that the auxiliary processor will remain in its current power state;
an amount of time required to cause the auxiliary processor to exit its current power state;
an operating frequency of the auxiliary processor;
a run queue of the auxiliary processor;
a power state of the application processor;
an operating frequency of the application processor;
a run queue of the application processor; and
a power state of a resource in the multiprocessor computing device.
